(19) United States
(12) Patent Application Publication
(10) Pub. No.: US 2011/0014983 A1
(43) Pub. Date: Jan. 20, 2011

(54) METHOD AND APPARATUS FOR MULTI-TOUCH GAME COMMANDS

(75) Inventor: Thomas Marshall Miller, IV, Los Angeles, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SONY COMPUTER ENTERTAINMENT AMERICA INC., Foster City, CA (US)

(21) Appl. No.: 12/502,638

(22) Filed: Jul. 14, 2009

(51) Int. Cl. A63F 9/24; A63F 13/00

(52) U.S. Cl. 463/37; 463/43; 463/46; 463/30

(57) ABSTRACT

Game commands may be entered via an electronic game peripheral by a user simultaneously contacting at least two of a plurality of discrete touch sensitive areas on a first surface of the device. A game command is determined based on the touch sensitive areas which are detected as being simultaneously in contact with the user. A second surface of the device, such as that opposite the first surface, may include a display that displays an indication of the game command.

### CROSS REFERENCE TO RELATED APPLICATION

This application is related to “METHOD AND APPARATUS FOR MULTI-TOUCH TEXT INPUT” U.S. application Ser. No. ______ filed ______, 2009 [Attorney Ref. SCEAUS 3.0-022], the disclosure of which is hereby incorporated herein by reference.

### BACKGROUND OF THE INVENTION

Video games are typically played by a user entering game commands on a gaming peripheral that is in communication with an apparatus on which the game is being executed. The peripherals may include input elements, such as buttons and joysticks that the user engages to enter a game command. For many games, entry of a game command may require the user to engage a plurality of different input elements simultaneously. For example, the user may need to simultaneously manipulate a joystick and depress a button (which may or may not require two hands) or multiple buttons.

Other devices also allow users to provide information to electronic devices via simultaneous actuation of a peripheral. For example, the shift key of a computer keyboard may be used to alter the commands sent to certain programs.

Moreover, portable communication devices, including PDAs and mobile phones, may receive text input based on a user contacting the device in some manner. For example, the user may depress a single key of a keyboard or touch a discrete area on a touchscreen of the device. The buttons or discrete areas may be mapped to text characters, such as alphanumeric characters, and the user may perform a sequence of individual contact actions to enter desired text content, such as a word, into the device. Some devices may also provide for simultaneous touch input, such as by simultaneously selecting a shift key and a letter on a keyboard that is displayed on a screen.

In addition to physical and virtual keyboards, other text entry devices also exist. For example, a stenotype machine allows a user to press multiple keys to enter certain text characters, symbols or various predefined words or phrases.

### BRIEF SUMMARY OF THE INVENTION

In one aspect, a method is provided for inputting game commands. It includes detecting user contact simultaneously with at least two of a plurality of discrete of touch sensitive areas, wherein input of a game commands requires simultaneous contact by a user with at least two of the touch sensitive areas. It also determines a game command based on the detected simultaneous user contact with at least two touch sensitive areas, and confirms user selection of the game command based on additional user contact with a touch-sensitive area.

In another aspect, a system is provided that includes a housing having a first surface and a second surface, the first and second surfaces being opposed to each other, at least two touch-sensitive regions on the second surface, and a screen on the first surface. It also includes a processor and a memory storing instructions executable by the processor. The instructions include identifying the regions that have been simultaneously touched by a user, determining a game command associated with the combination of the regions simultaneously touched by the user, and displaying the game command on the screen.

In still another aspect, a system is provided that includes a first, second, third and fourth user-selectable region, each region being separately selectable from the others and a screen. It further includes a processor and a memory storing instructions executable by the processor, where the instructions include: identifying the first, second and third regions that have been simultaneously selected by the user; determining a game command based on the combination of the identified regions; displaying the determined game command on the screen in a first area of the screen; determining whether the user has selected the fourth user-selectable region and; displaying the determined game command on the screen in a second area of the screen, different from the first area, based on the user selecting the fourth-selectable region.

A further aspect relates to a system having a housing with a first surface and a second surface, the first and second surfaces being opposed to each other, at least two touch-sensitive regions on the second surface, and a screen on the first surface. It also includes a processor and a memory storing instructions executable by the processor. The instructions comprise identifying the regions that have been simultaneously touched by a user, determining a game command associated with the combination of the regions simultaneously touched by the user, and displaying the game command on the screen.

### BRIEF DESCRIPTION OF THE DRAWINGS

Other objects and advantages of the present invention will be apparent from the following detailed description of the present preferred embodiments, which description should be considered in conjunction with the accompanying drawings in which like reference indicate similar elements and in which:

FIG. 1 is a schematic block diagram of a system in accordance with an aspect of the invention.

FIG. 2 is perspective view of a front surface and side surfaces of a device in accordance with an aspect of the invention.

FIG. 3 is perspective view of a back surface and side surfaces of a device in accordance with an aspect of the invention.

FIG. 4 is perspective view of a back surface and side surfaces of a device in accordance with an aspect of the invention.

FIG. 5 is perspective view of a back surface of the device during a stage of user operation in accordance with an aspect of the invention.

FIG. 6 is diagram of a portion of the Braille alphabet.

FIG. 7 is functional diagram of association between portions of a device and the Braille alphabet in accordance with an aspect of the invention.

FIG. 8 is perspective view of a front surface of the device during a stage of user operation in accordance with an aspect of the invention.

FIG. 9 is perspective view of a front surface of the device during another stage of user operation in accordance with an aspect of the invention.

FIG. 10 is perspective view of a front surface of the device during another stage of user operation in accordance with an aspect of the invention.

FIG. 11 is perspective view of a front surface of the device during various stages of user operation in accordance with an aspect of the invention.

FIG. 12 illustrates screen shots of a device in accordance with an aspect of the invention.

FIG. 13 is perspective view of a front surface of the device during a stage of user operation in accordance with an aspect of the invention.

FIG. 14 is flowchart in accordance with an aspect of the invention.

### DETAILED DESCRIPTION

In one aspect, the system and method provides for the entry of game commands by a user simultaneously contacting at least two of a plurality of discrete touch sensitive areas of a touch sensitive element.

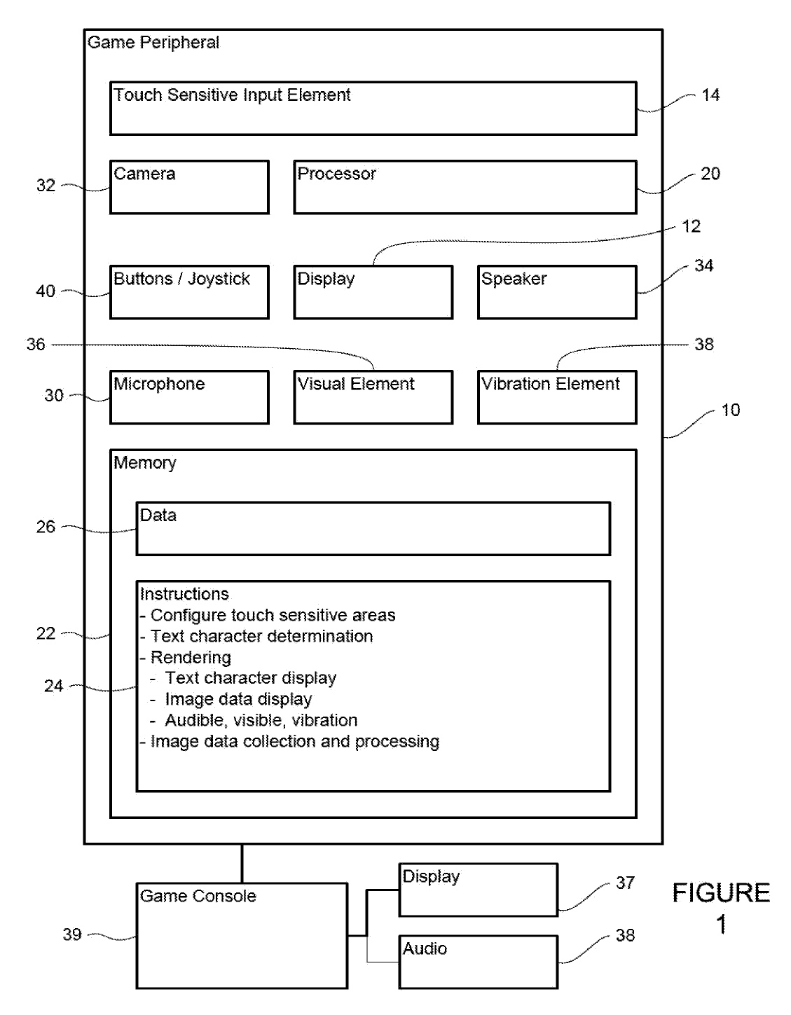

As shown in FIG. 1, a device 10 in accordance with one aspect of the invention comprises a display 12, such as an LCD screen, a touch sensitive input element 14 and other components typically present in electronic game peripherals. For example, the device may include joysticks and buttons 40. The game peripheral 10 may, also for example, be a portable, handheld communication device, such as a PDA, mobile telephone, etc.

The device 10 may include a processor 20 and a memory 22. The memory 22 stores information accessible by the processor 20, including instructions 24 for execution by the processor 20, and data 26 which is retrieved, manipulated or stored by the processor 20. The memory may be of any type capable of storing information accessible by the processor; by way of example, hard-drives, ROM, RAM, CD-ROM, DVD, write-capable memories, and read-only memories.

The instructions 24 may comprise any set of instructions to be executed directly (e.g., machine code) or indirectly (e.g., scripts) by the processor. The terms “instructions,” “steps” and “programs” may be used interchangeably herein. The functions, methods and routines of the program in accordance with the present invention are explained in more detail below.

The data 26 may be retrieved, stored or modified by the processor 20 in accordance with the instructions 24. The data may be stored in any manner known to those of ordinary skill in the art such as in computer registers, in records contained in tables and relational databases, or in XML files. The data may also be formatted in any computer readable format such as, but not limited to, binary values, ASCII or EBCDIC (Extended Binary-Coded Decimal Interchange Code). Moreover, any information sufficient to identify the relevant data may be stored, such as descriptive text, proprietary codes, pointers, or information which is used by a function to calculate the relevant data.

Although the processor and memory are functionally illustrated in FIG. 1 as within the same block, it will be understood by those of ordinary skill in the art that the processor and memory may actually comprise multiple processors and memories that may or may not be stored within the same physical housing. For example, some of the instructions and data may be stored on a removable DVD, CD-ROM and others within a read-only computer chip. Some or all of the instructions and data may be stored in a location physically remote from, yet still accessible by, the processor. For example, some or all of the instructions may be downloaded or accessed over a network (not shown). Similarly, the processor may actually comprise a collection of processors which may or may not operate in parallel.

All or a portion of the instructions 24 may comprise instructions for detecting and processing game commands from a user, based on a user simultaneously contacting at least two discrete touch sensitive areas of a plurality of touch sensitive areas of the touch sensitive element 14, in accordance with aspects of the present invention. In one embodiment, the instructions may include touch sensitive area mapping instructions, which may configure the touch sensitive areas of the touch sensitive element, for receiving game commands based on simultaneous user contact with at least two of the areas, in accordance with selected combination of regions representative of game commands; touch sensitive area contact detection and processing instructions, which may determine input of a game command based on detection of a user simultaneously contacting at least two selected touch sensitive areas of the touch sensitive element; imaging instructions, which may provide for collection and processing of data representative of images of the touch sensitive areas obtained from an imaging device that may be included with the device; and rendering instructions, which may provide for display of a determined game command or other data, such as images represented by the image data, and for generating visible, audible and vibrational output.

In one aspect, the device 10 communicates with a game console 39 by providing commands to the console. Game console 39 may audio and visual signals to speakers 37 and display 37.

In addition, the device 10 may include a visual element 36, which is distinct from the display 12, such as an LED, and may be energized based on control signals supplied by the processor 20. In addition, the device 10 may provide haptic feedback such as via a vibrational element 38, such as a piezoelectric device, which may be activated, based on control signals supplied by the processor 20, to cause the device to vibrate.

In one embodiment, the touch sensitive element 14 may include a conventional touchscreen panel, such as a pressure or temperature sensitive touchscreen panel, having a plurality of touch sensitive areas arranged in the form of a grid, and conventional components for detecting contact by a user with a touch sensitive area of the panel, and for generating data signals identifying a discrete touch sensitive area(s) of the panel at which contact with a user was detected. The identification may be the location of the area on the grid, such as the row and column of the grid. For example, if the touch sensitive element 14 is a touchscreen, the screen may identify the particular pixel at which the screen is touched.

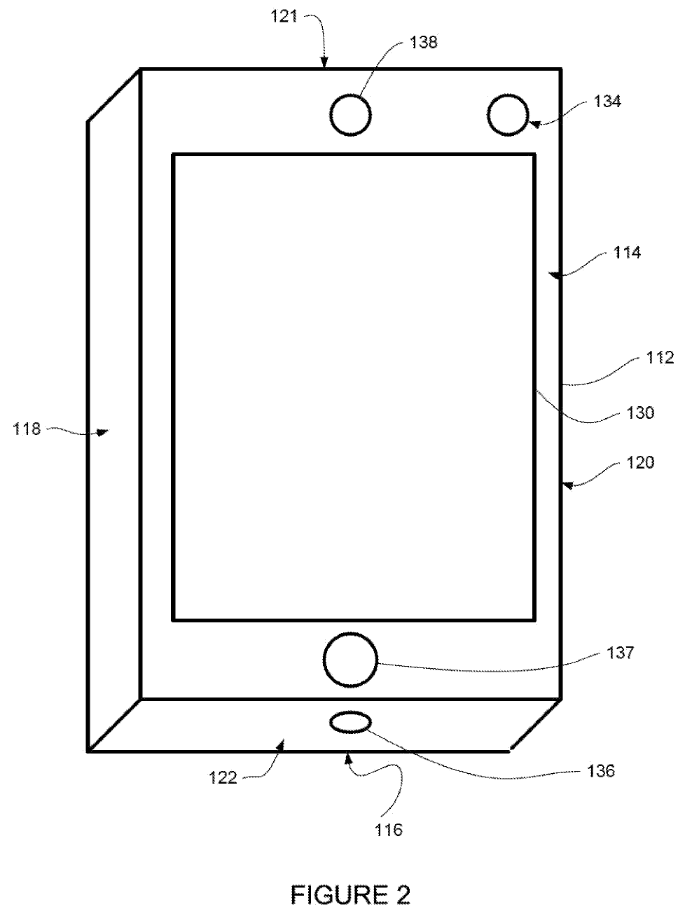

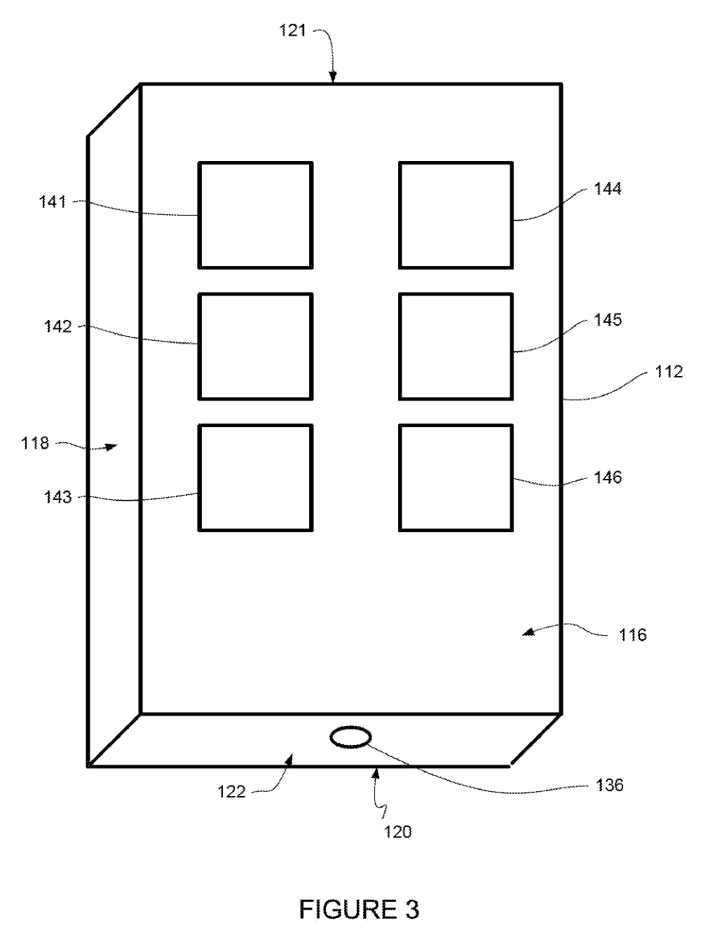

In accordance with one embodiment of the invention, referring to FIG. 2, a portable electronic game peripheral 100 may include a housing 112. The components of the device 100 are contained within an interior (not shown), or are a part, of the housing 112. Referring to FIG. 2, and also to FIG. 3, the housing 112 may have two sides (such as but not limited to a box shape) such that it has a front outer surface 114, a back outer surface 116, opposing side outer surfaces 118, 120, a top outer surface 121, and a bottom outer surface 122. The front surface 114 includes a display 130, such as a touch-sensitive LCD screen. In addition, the device may include a visible light element 134, such as an LED, a microphone 136 and a depressable button 137. It may also include a speaker 138. The device may include more or less user input components as well, such as scroll wheels and more buttons.

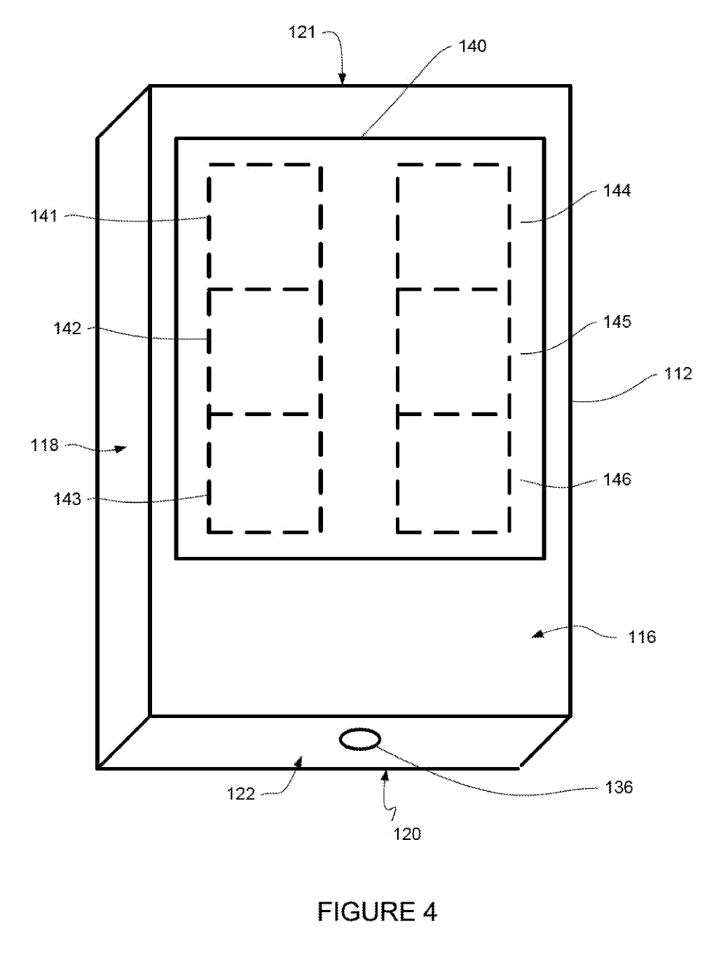

As shown in FIG. 3, the back surface 116 may include a plurality of touch sensitive regions 141-146. For example, each region may comprise a separate button spaced apart from other buttons. Alternatively, as shown in FIG. 4, the processor may associate different regions of a single touch-sensitive component, such as a touchpad 150, with different regions 141-46. Other user-actuable elements may also be used.

The interior of the housing 112 may contain the processor 200 connected to a memory 220. The processor 200 is communicatively coupled to the display 130, the visible light element 134, the microphone 136, the button 137 and the touchpad 150.

In accordance with one aspect of the present invention, game commands may be entered by activating regions of the touch sensitive input element 14 whereby some game commands require two regions to be activated simultaneously. In that regard, detection of simultaneous contact by the user with at least two of the touch sensitive areas is required to register at least some game commands the device.

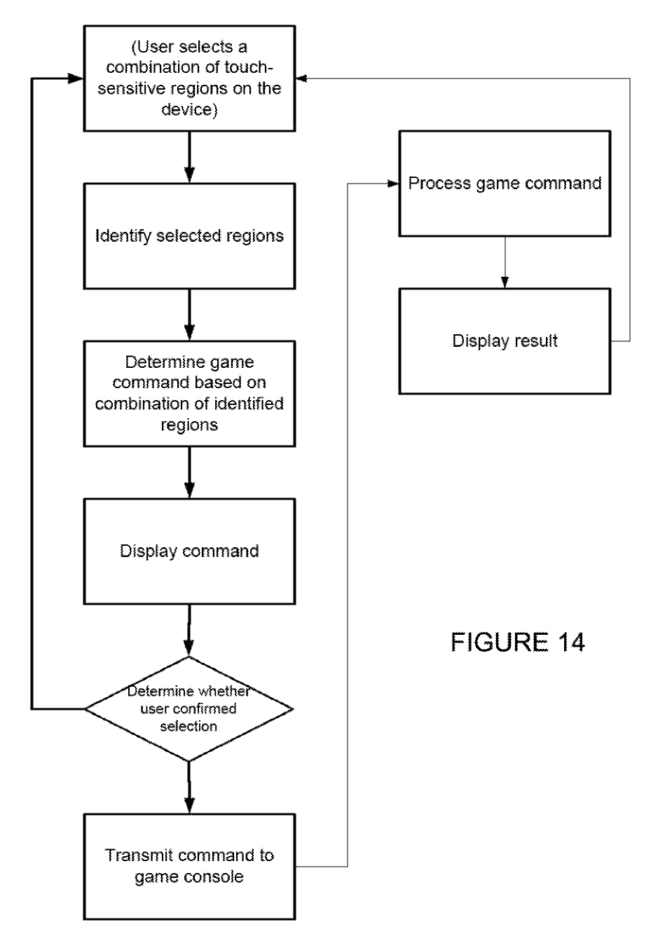

In addition to the operations illustrated in FIG. 14, various operations in accordance with a variety of aspects of the invention will now be described. It should be understood that the following operations do not have to be performed in the precise order described below. Rather, various steps can be handled in reverse order or simultaneously.

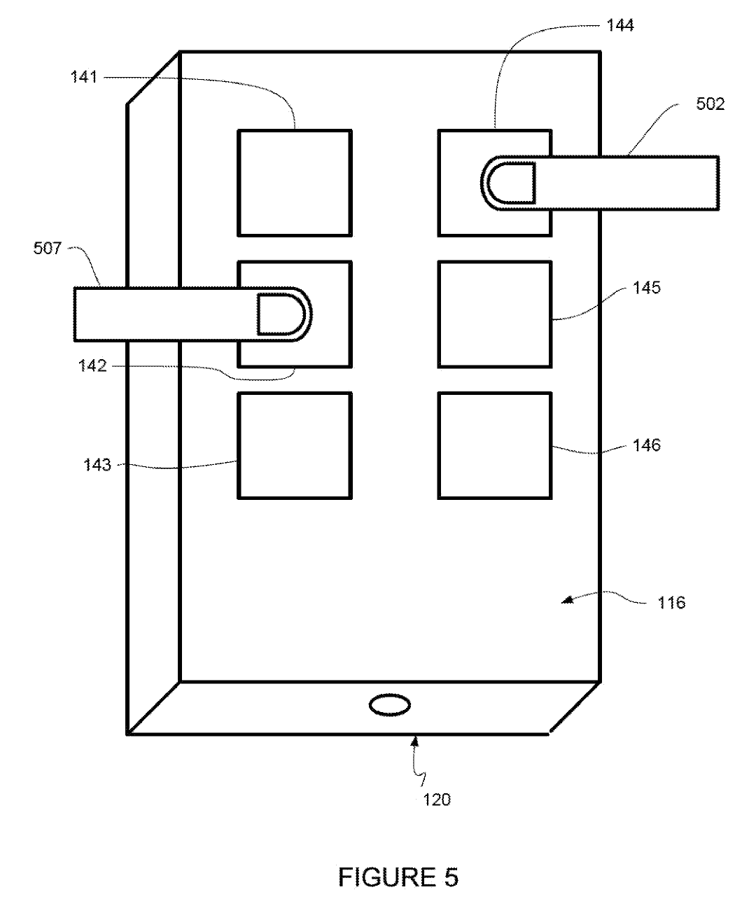

In operation, the user touches one or more of the touch sensitive regions on the back of the device. As shown in FIG. 5 which is a view of the device from the back, the user may simultaneously depress regions 144 and 142 with their fingers 502 and 507, respectively.

The device then determines whether the depressed regions correspond with a game command. For example, the processor may map different combinations of regions 141-46 to different game commands.

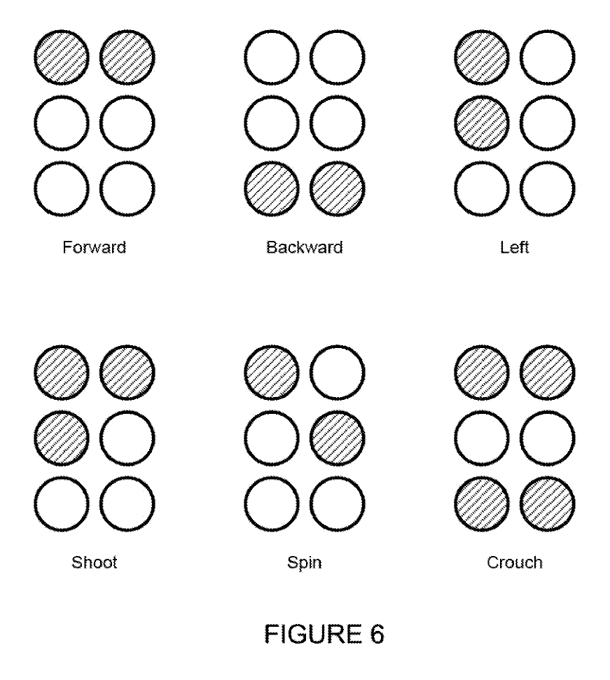

For example, the device may determine whether the particular combination of depressed regions correspond with one of a set of game commands. FIG. 6 illustrates a set of game commands. Each command is associated with a different combination of selected regions. The regions may be arranged relative to one another in a rectangle containing two columns of three dots each. A particular letter is represented by selecting some regions and not others For example, the command to “spin” may be represented by selecting the top-left and middle-right regions as indicated by the cross-hatching in FIG. 6. It will be understood that system and method is not limited to any particular combinations of regions or commands. In fact, many other game commands may be selected.

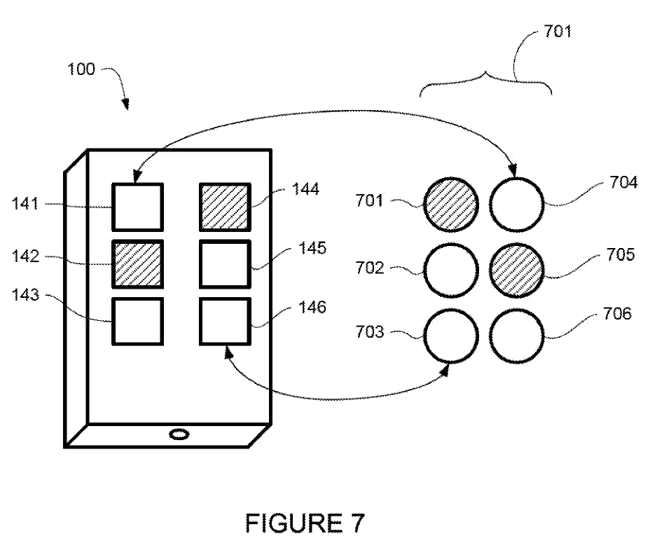

In that regard, as shown in FIG. 7, top-left touch-sensitive region 141 of the device 100 may be associated with the top-right position 704 of a game command 701. Similarly, bottom-right region 146 of the device 100 may be associated with the bottom-left position 703 of a game command. The processor 200 maps each of the game commands of the set to different combinations of regions 140-46. For example, referring to the cross-hatching of FIG. 7, the command “spin” 701 may be mapped to regions 142 and 144.

Thus, as shown in FIG. 5 which shows the back of the device, when a user uses his right middle finger 507 to touch region 142 and his left index finger 502 to touch region 144, such activation may be associated with the command “spin”.

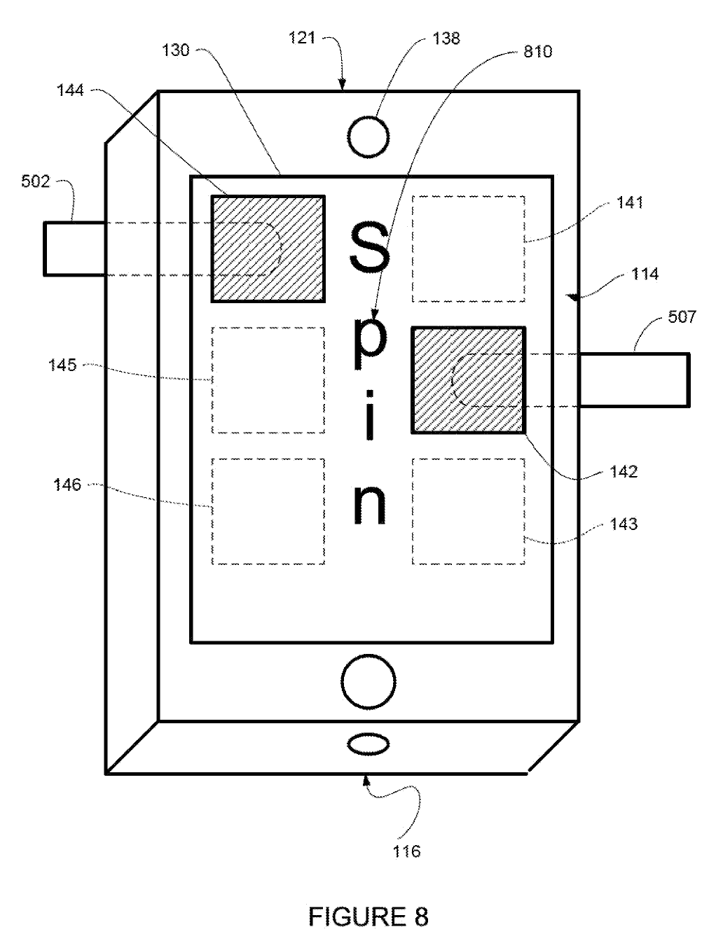

FIG. 8 illustrates how the device may be operated when the user is viewing the display 130 of the device. When the user is facing the front surface 114, the touch-sensitive region 144—which is at the top-right portion of the back surface 116—will correspond with the top-left portion of the display screen 130. Similarly, touch-sensitive region 142—which is at the middle-left portion of the back surface—will correspond with the middle-right portion of the display screen 130. The relative positions of the touch-sensitive regions are indicated by references 141-46.

When the user touches the portions 142 and 144 on the back of the device (such as with left index finger 502 and right middle finger 507), the display 130 on the front of the device may provide visual or audio feedback to the user. For example, the processor may highlight the portion of the screen 130 that is above the touch-sensitive portion 144 (as shown in FIG. 8). Similarly, the speaker 138 may emit a sound such as a click.

Once the processor determines that one or more regions 141-46 have been touched, it determines how many regions are being simultaneously selected. In that regard, it may start a timer whereby all portions that are selected at any point during an elapsed period, or are selected at moment the expiration of the period, are considered to have been simultaneously selected.

When the processor determines the portions that have been simultaneously selected, it determines the game command that corresponds with those portions. For example, memory 22 may store a lookup table where the lookup values represent various combinations and are associated with game commands.

When the appropriate game command is found, it may be displayed on the electronic display. For example, the word “Spin” may be shown at the center 810 of the screen. Alternatively, a symbol representative of spinning, or an animation of character spinning (which may include a graphic of a character received by the device 10 from the game console) may also be shown.

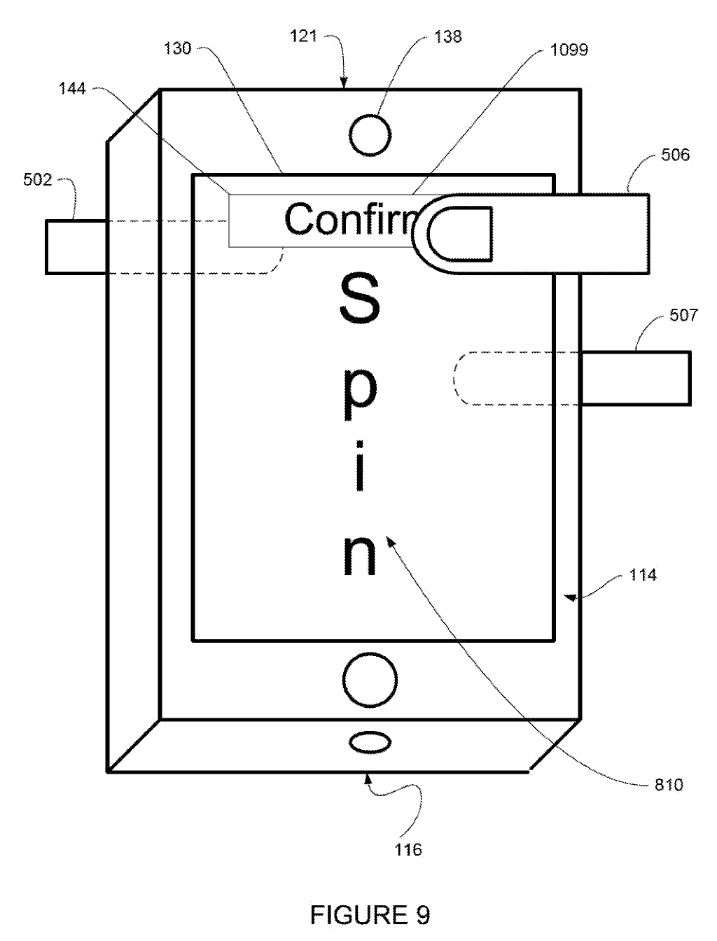

In one aspect, the user will be required to confirm that they intended to select the command. For example, the device may permit or require the user to confirm the command while simultaneously selecting the command. As shown in FIG. 9, the screen 130 may display a “Confirm” button 901, whereby the user confirms the command “Spin” by pressing the portion of the screen associated with the button 901, such as by using their thumb 506. In that regard, the user may be effectively required to select the confirm button 1099 with his thumb while simultaneously selecting regions on the back surface with fingers 502 and 507. Alternatively, the user may confirm the command by touching anywhere on the screen 130 or by waiting for a period without locking the letter.

Once the game command has been confirmed, it may be transmitted and processed by the game console accordingly. For example, the game console 39 may cause an in-game character to spin, displaying the result on display 37.

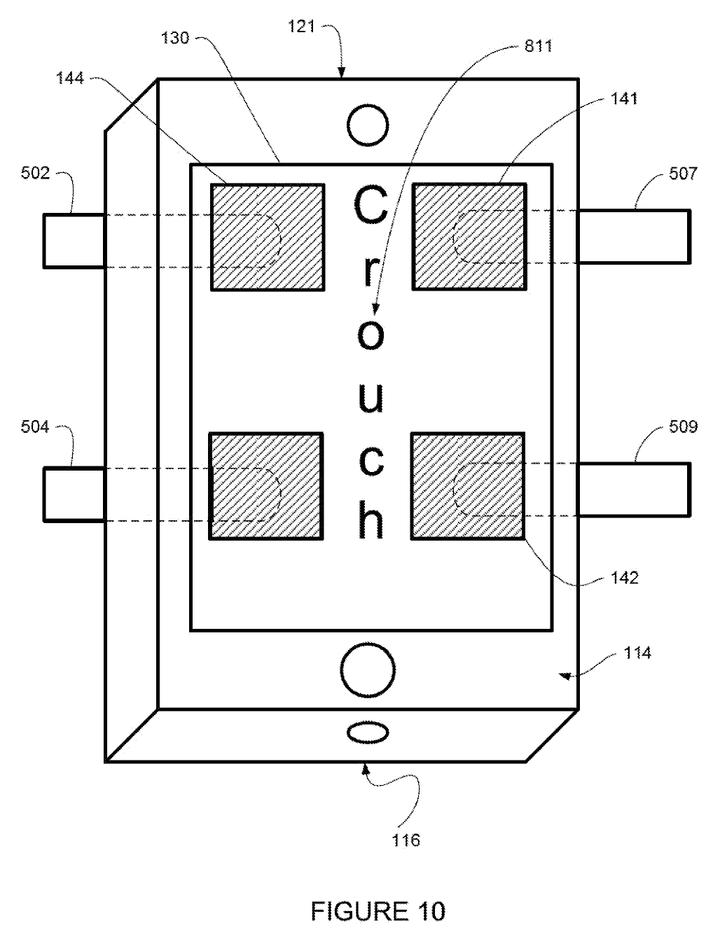

The process may be repeated to enter subsequent game commands. For example, as shown in FIG. 10, the user may simultaneously select portions 141, 142 and 144 to select the game command “Crouch”, which is displayed at the center 811 of the screen.

The system and method is particularly advantageous with respect to its flexibility to accommodate various alternatives.

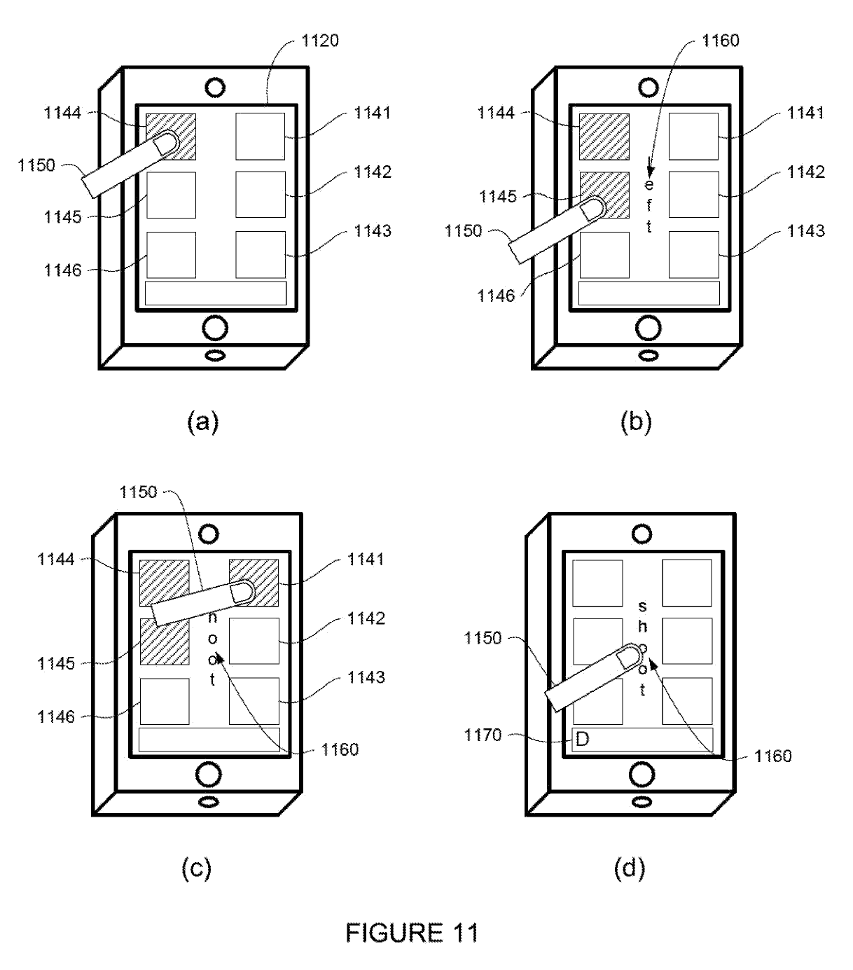

FIG. 11 provides an alternative aspect wherein different game commands are selected based on simultaneous selection of the regions, even though the regions are not necessarily simultaneously activated. The processor may associate, and display, a touch-sensitive screen 1120 with different portions 1141-46. As shown in FIG. 11(a), the user may select (or deselect if selected) each region by touching it, such as by touching region 1144 with left index finger 1150. The processor may then show the selection by highlighting the portion. As shown in FIG. 11(b), the user may select another region 1145 by touching it after the user touched region 1144. A game command (e.g., “Left”) matching these now simultaneously-selected regions 1144-45 may be displayed at the center 1160 of the screen. If another region is selected, such as region 1141 shown in FIG. 11(c), the game command (e.g., “Shoot”) matching the currently simultaneously-selected regions 1141, 1144-45 may be displayed. To confirm the selection, the user may confirm the displayed command by touching the center 1160 of the screen, in which case it is processed by the game console. Although FIG. 11 illustrates an aspect whereby the command-confirmation area 1160 is different than the command selection areas 1141-46, such areas may overlap—especially if the command-confirmation area is displayed after the command has been selected.

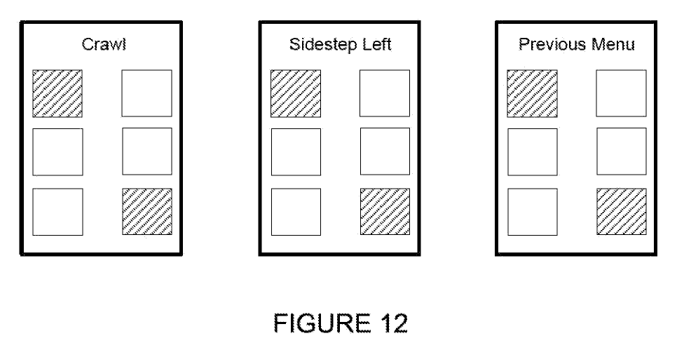

In still another aspect, the combinations may be mapped to different sets of game commands. For example, as shown in FIG. 12, the same combinations of simultaneously-selected regions may result in different game commands depending on the set of commands. In some aspects, the user may select the command set by selecting certain combinations of regions.

In a further aspect, a variety of feedback may be provided to the user to confirm the selection of a command. For example, the processor 200 may energize a vibrational element 38 contained within the housing 112, thereby causing the device 100 to vibrate in the hands of the user. In still another aspect, also following determination of the command, the processor 200 may generate audio signals and transmit same to the speaker 138 such as the name of the determined command. In a further embodiment, the processor 200 may generate a control signal causing the LED 134 to illuminate, following the determination of the command.

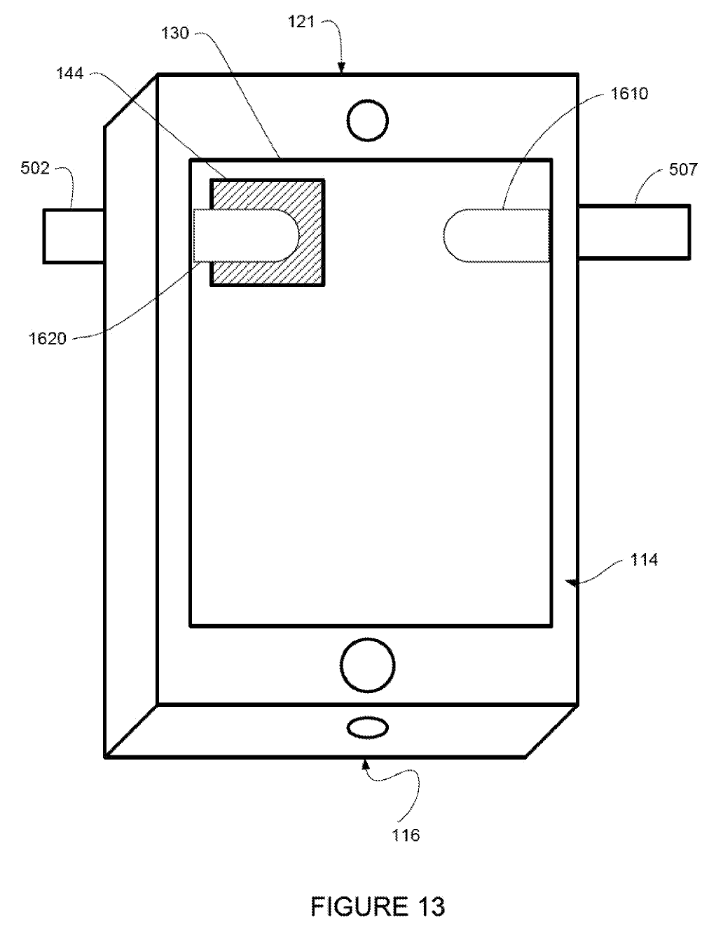

In an another aspect of the invention and as shown in FIG. 13, the device includes a component for detecting the proximity of the fingers at the bottom surface the device and displays, on the screen, representations 1610 and 1620 of the user's fingers. For example, the back surface may include a number of infrared transmitters and detectors. The device may further include a camera on the back surface, in which case streaming video of the fingers below the device may also be shown.

In one aspect, the selection of a command may also be confirmed or locked by selecting a dedicated hardware button on the bottom or other portion of the device, or by selecting a specific combination of regions.

Moreover, the location of the regions can be changed to the sides or other locations or configurations. For example, buttons may be disposed in six slots on the sides of the device for easier gripping.

Certain aspects of the system and method provide advantages over certain other peripherals. For example, for many peripherals, it is difficult to operate more than a few buttons at a time. Moreover, the user may have to move the same finger (such as a thumb) from one button to another to execute certain combinations. The system and method shown in FIG. 8, on the other hand, permits users to quickly and easily select different combinations of 6 different touch-sensitive regions without moving a single finger from region to another. As a result, the user has over 64 commands at his or her disposal at a single “click”. [NOTE TO SCEA—2̂6, yes?] If two more regions of the front surface 114 are allocated to the thumbs, the number of commands increases to 256.

In other aspects, one or both of the device 10 and the console 39 may comprise any device capable of processing instructions and transmitting data to and from humans and other computers or devices, including general purpose computers, network computers lacking local storage capability, PDAs with modems and Internet-capable wireless phones, digital video recorders, cable television set-top boxes or consumer electronic devices.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for inputting game commands comprising:
detecting user contact simultaneously with at least two of a plurality of discrete of touch sensitive areas, wherein input of a game commands requires simultaneous contact by a user with at least two of the touch sensitive areas;
determining a game command based on the detected simultaneous user contact with at least two touch sensitive areas; and
confirming user selection of the game command based on additional user contact with a touch-sensitive area.

2. The method of claim 1, wherein confirming user selection of the game command comprises at least one of the user contacting another touch sensitive area or depressing a button.

3. The method of claim 1 further comprising providing feedback following at least one of the determination of the game command or confirming the user selection.

4. The method of claim 3, wherein the feedback comprises at least one of an audible, a visible or a vibrational output.

5. The method of claim 3, wherein the feedback comprises display of the determined game command on a display.

6. The method of claim 1, wherein the touch sensitive areas are external to the display.

7. The method of claim 1, wherein the game command is displayed on a first portion of the display before the confirmation.

8. The method of claim 7, wherein the game command is displayed on a second portion of the display after the confirmation, the second portion being different than the first portion.

9. The method of claim 1 further comprising displaying indicia representative of the detected areas as they are being contacted by the user.

10. A system comprising:
a housing having a first surface and a second surface, the first and second surfaces being opposed to each other;
at least two touch-sensitive regions on the second surface;
a screen on the first surface;
a processor;
a memory storing instructions executable by the processor;
the instructions comprising:
identifying the regions that have been simultaneously touched by a user,
determining a game command associated with the combination of the regions simultaneously touched by the user, and
displaying the game command on the screen.

11. The system of claim 10 wherein each touch-sensitive regions is a button spaced apart from the other regions.

12. The system of claim 10 wherein each touch-sensitive regions comprises a different portion of the same touch-sensitive component.

13. The system of claim 12 wherein the touch-sensitive component is a touchpad.

14. The system of claim 10 wherein the memory stores a set of game commands and associates each different game command of the set with a different combination of selected regions.

15. The system of claim 10 wherein the instructions further comprise detecting the proximity of a user's fingers near the touch-sensitive regions, and displaying on the display an indication of such proximity.

16. The system of claim 10 wherein the instructions further comprise displaying, on the display, an indication of the regions being touched by the user.

17. The system of claim 16 wherein the indication comprises displaying an indication on a portion of the screen that corresponds with a touched region.

18. The system of claim 17 wherein the portion of the screen is opposed to the touched region.

19. The system of claim 17 further comprising a game console for receiving the game command.

20. The system of claim 19 further comprising a display in communication with the game console, wherein the display displays a game based on the game commands.

21. A system comprising:
a first, second, third and fourth user-selectable region, each region being separately selectable from the others;
a screen;
a processor;
a memory storing instructions executable by the processor;
the instructions comprising:
identifying the first, second and third regions that have been simultaneously selected by the user,
determining a game command based on the combination of the identified regions,
displaying the determined game command on the screen in a first area of the screen,
determining whether the user has selected the fourth user-selectable region, and
displaying the determined game command on the screen in a second area of the screen, different from the first area, based on the user selecting the fourth-selectable region.

22. The method of claim 21 wherein the first, second and third regions are different regions of the same touchpad.

23. The method of claim 21 wherein the display is a single touch screen and the first, second and third regions are different regions of the touch screen.

24. The method of claim 21 wherein the display is a single touch screen and the first, second, third and fourth regions are different regions of the touch screen.

25. The method of claim 21 wherein the display is a single touch screen and the first, second, third are different regions of the touch screen, wherein the fourth region is also a region of the display screen, and wherein the fourth region is indicated after the game command is determined.

26. The method of claim 21 wherein the game command is determined based on the correspondence between the identified first, second and third regions with the Braille alphabet.

27. A system comprising:
a housing having a first surface and a second surface, the first and second surfaces being opposed to each other;
at least two touch-sensitive regions on the second surface;
a screen on the first surface;
a processor;
a memory storing instructions executable by the processor;
the instructions comprising:
identifying the regions that have been simultaneously touched by a user,
determining a game command associated with the combination of the regions simultaneously touched by the user, and
displaying the game command on the screen.
